(19) United States
(12) Patent Application Publication
(10) Pub. No.: US 2026/0093152 A1
(43) Pub. Date: Apr. 2, 2026

(54) DISPLAY PANEL AND DISPLAY DEVICE

(71) Applicant: Shanghai Tianma Micro-electronics Co., Ltd., Shanghai (CN)

(72) Inventors: Yang ZENG, Shanghai (CN); Shengtao ZHU, Shanghai (CN); Yuan DING, Shanghai (CN)

(21) Appl. No.: 19/236,225

(22) Filed: Jun. 12, 2025

(30) Foreign Application Priority Data
Sep. 29, 2024 (CN) 202411380039.0

(51) Int. Cl. G02F 1/1677; G02F 1/167; G02F 1/16757; G02F 1/1676; G02F 1/1679

(52) U.S. Cl. CPC G02F 1/1677; G02F 1/167; G02F 1/16757; G02F 1/1676; G02F 1/1679

(57) ABSTRACT

The present disclosure provides a display panel and a display device. The display panel includes a first substrate and an electrophoretic display layer located on one side of the first substrate, and the electrophoretic display layer includes a plurality of display units, where a display unit includes an electrophoretic liquid and a plurality of electrophoretic particles located in the electrophoretic liquid. The display panel also includes a first functional layer, where the first functional layer is located on a side of the electrophoretic display layer facing a display surface of the display panel, and the first functional layer is a low refractive index layer.

### CROSS-REFERENCE TO RELATED APPLICATION

This application claims the priority of Chinese Patent Application No. 202411380039.0, filed on Sep. 29, 2024, the content of which is incorporated herein by reference in its entirety.

### TECHNICAL FIELD

The present application relates to the field of display technology, in particular to a display panel and a display device.

### BACKGROUND

Electronic paper display panels have the advantages of low power consumption, ultra-thinness, lightness, and having display performance close to the natural paper, and have been increasingly widely used in life.

Electronic paper display panels are generally reflective display panels, which display images by reflecting external incident light through internal electrophoretic particles. However, in existing technology, some large-angle light reflected by electrophoretic particles cannot be emitted from the electronic paper display panel, affecting display brightness. Therefore, a solution is urgently needed.

### SUMMARY

One aspect of the present disclosure provides a display panel, including a first substrate and an electrophoretic display layer located on one side of the first substrate, the electrophoretic display layer includes a plurality of display units, where a display unit includes an electrophoretic liquid and a plurality of electrophoretic particles located in the electrophoretic liquid. The display panel further includes a first functional layer, and the first functional layer is located on a side of the electrophoretic display layer facing a display surface of the display panel, where the first functional layer is a low refractive index layer.

Another aspect of the present disclosure provides a display device including a display panel, and the display panel includes a first substrate and an electrophoretic display layer located on one side of the first substrate, the electrophoretic display layer includes a plurality of display units, where a display unit includes an electrophoretic liquid and a plurality of electrophoretic particles located in the electrophoretic liquid. The display panel further includes a first functional layer, and the first functional layer is located on a side of the electrophoretic display layer facing a display surface of the display panel, where the first functional layer is a low refractive index layer.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solutions of the embodiments of the present disclosure, the accompanying drawings essential for implementing the embodiments will be briefly introduced below. Apparently, the drawings described below are merely some of the embodiments of the present disclosure. For persons having ordinary skills in the art, other drawings may be obtained based on these drawings without making creative efforts.

FIG. 1 is a schematic diagram of the structure of a display panel in the existing technology;

FIG. 2 is a schematic diagram of the structure of a display panel in accordance with an embodiment of the present disclosure;

FIG. 3 is a schematic diagram illustrating a relationship between the reflectance and the wavelength of light when d=250 nm;

FIG. 4 is a schematic diagram of the structure of another display panel in accordance with an embodiment of the present disclosure;

FIG. 5 is a schematic diagram of the structure of another display panel in accordance with an embodiment of the present disclosure;

FIG. 6 is a schematic diagram of the structure of another display panel in accordance with an embodiment of the present disclosure;

FIG. 7 is a schematic diagram of the structure of another display panel in accordance with an embodiment of the present disclosure;

FIG. 8 is a schematic diagram of the structure of another display panel in accordance with an embodiment of the present disclosure;

FIG. 9 is a schematic diagram of the structure of another display panel in accordance with an embodiment of the present disclosure;

FIG. 10 is a schematic diagram of the structure of another display panel in accordance with an embodiment of the present disclosure;

FIG. 11 is a schematic diagram of the structure of another display panel in accordance with an embodiment of the present disclosure;

FIG. 12 is a schematic diagram of the structure of another display panel in accordance with an embodiment of the present disclosure;

FIG. 13 is a schematic diagram of the structure of another display panel in accordance with an embodiment of the present disclosure;

FIG. 14 is a schematic diagram of the structure of another display panel in accordance with an embodiment of the present disclosure; and

FIG. 15 is a schematic diagram of a display device in accordance with an embodiment of the present disclosure.

### DETAILED DESCRIPTION

In order to better understand the technical solution of the present disclosure, the embodiments of the present disclosure are described in detail below with reference to the accompanying drawings.

It should be apparent that the described embodiments are merely some of the embodiments of the present disclosure, rather than all of the embodiments. Based on the embodiments in the present disclosure, all other embodiments obtained by persons having ordinary skills in the art without making creative effort are within the scope of protection of the present disclosure.

The terms used in the embodiments of the present disclosure are merely for the purpose of describing the specific embodiments and are not intended to limit the present disclosure. The singular forms “a”, “said” and “the” used in the embodiments of the present disclosure and the appended claims are also intended to include plural forms unless the context clearly indicates other meanings.

It should be understood that the term “and/or” used in this disclosure is merely a description of the associative relationship of associated objects, indicating that there may be three relationships. For example, “A and/or B” may represent: A exists alone, A and B exist at the same time, and B exists alone. In addition, the character “/” in this disclosure generally indicates that the associated objects before and after are in an “or” relationship.

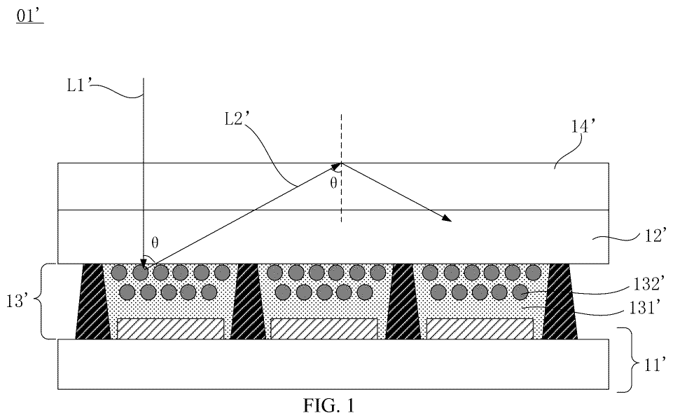

FIG. 1 is a schematic diagram of the structure of a display panel in the existing technology.

In the existing technology, as shown in FIG. 1, the display panel 01′ includes a first substrate 11′ and a second substrate 12′ configured opposite to each other, an electrophoretic display layer 13′ is configured between the first substrate 11′ and the second substrate 12′, and the second substrate 12′ is located on the side of the electrophoretic display layer 13′ facing the display surface of the display panel 01′. A cover plate 14′ is also configured on the side of the second substrate 12′ facing the display surface of the display panel 01′, and the cover plate 14′ may be a glass cover plate.

The electrophoretic display layer 13′ includes an electrophoretic liquid 131′ and a plurality of electrophoretic particles 132′. The electrophoretic particles 132′ may scatter the external incident light L1′. The light scattered into the air may be used to implement the image display of the display panel 01′.

After conducting the investigation, the applicant of the present disclosure has found that in the display panel 01′, the electrophoretic particles 132′ may scatter the external incident light to various angles. As shown in FIG. 1, the large-angle light L2′ scattered by the electrophoretic particles 132′ that is greater than or equal to the total reflection angle θ cannot be directly emitted into the air and may be absorbed after multiple reflections inside the display panel 01′, resulting in a lower display brightness of the display panel 01′, thereby affecting the display quality.

The applicant of the present disclosure has provided a solution to the problem present in the existing technology through careful and in-depth investigation.

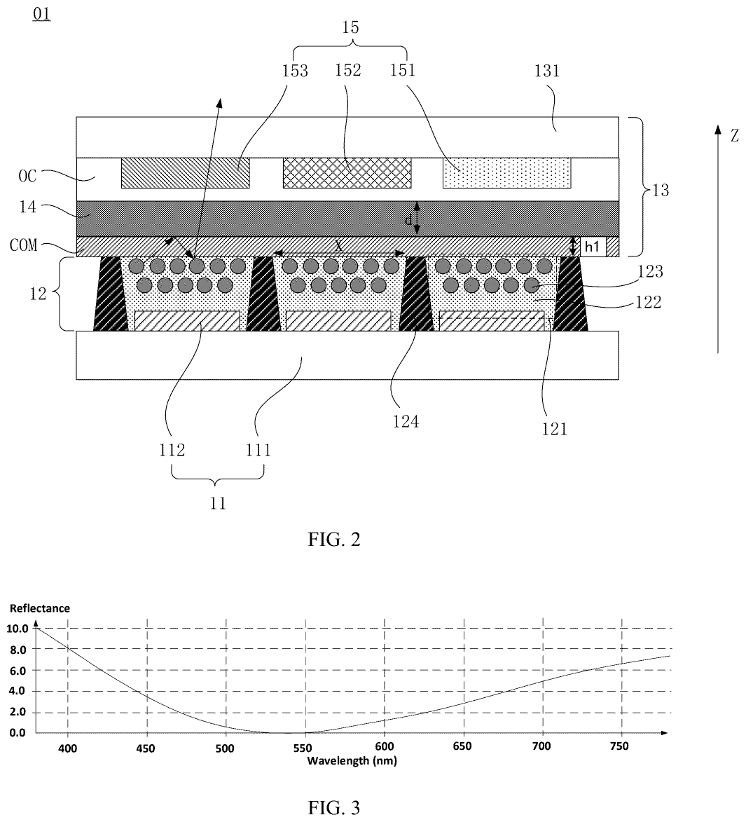

FIG. 2 is a schematic diagram of the structure of a display panel in accordance with an embodiment of the present disclosure.

The embodiments of the present disclosure provide a display panel 01. As shown in FIG. 2, the display panel 01 includes a first substrate 11 and an electrophoretic display layer 12 located on one side of the first substrate 11. The first substrate 11 includes a first base 111 and a driving electrode 112 configured on the first base 111. The electrophoretic display layer 12 is located on the side of the driving electrode 112 facing the display surface of the display panel 01.

The display panel 01 further includes a second substrate 13. The second substrate 13 is located on the side of the electrophoretic display layer 12 facing the display surface of the display panel 01. The second substrate 13 may be configured opposite to the first substrate 11.

The second substrate 13 includes a second base 131 and a common electrode COM configured on the second base 131. The common electrode COM is located on the side of the second base 131 facing the electrophoretic display layer 12.

As shown in FIG. 2, the electrophoretic display layer 12 includes a plurality of display units 121, and a display unit 121 includes an electrophoretic liquid 122 and a plurality of electrophoretic particles 123 located in the electrophoretic liquid 122. The electrophoretic liquid 122 is light-transmissive, and the electrophoretic particles 123 may scatter external incident light, and the light scattered into the air may implement the image display of the display panel 01.

Exemplarily, different images may be displayed by applying a voltage to the driving electrode 112 and the common electrode COM to form an electric field that drives the electrophoretic particles 123 to move. The display panel 01 may be an electronic paper display panel.

The display panel 01 further includes a first functional layer 14, which is located on the side of the electrophoretic display layer 12 facing the display surface of the display panel 01.

Optionally, the first functional layer 14 is configured in the second substrate 13, and the first functional layer 14 is located on the side of the second base 131 facing the electrophoretic display layer 12.

The first functional layer 14 is a low refractive index layer.

Optionally, the refractive index of the first functional layer 14 is n, where n<1.5.

In the embodiments of the present disclosure, the first functional layer 14 is configured on the side of the electrophoretic particles 123 facing the display surface of the display panel 01, so that the light scattered by the electrophoretic particles 123 for display may pass through the first functional layer 14. Since the refractive index of the first functional layer 14 is relatively small, the large-angle light scattered by the electrophoretic particles 123 may be reflected back to the electrophoretic display layer 12 at the interface of the first functional layer 14. After being scattered again by the electrophoretic particles 123 in the electrophoretic display layer 12, the reflected light may be easily converted into small-angle light and emitted into the air as light with an angle less than the total reflection angle. That is, the large-angle light that initially cannot be directly emitted from the display panel 01 into the air may be converted into small-angle light and emitted into the air, which is beneficial to increasing the amount of light scattered into the air by the electrophoretic particles 123, thereby increasing the display brightness of the display panel 01 and improving the display quality.

It should be noted that, in the present disclosure, large-angle light may refer to light having an angle greater than or equal to the total reflection angle θ in FIG. 1, and small-angle light may refer to light having an angle less than the total reflection angle θ.

Optionally, n<1.3, since the smaller the refractive index of the first functional layer 14, the stronger the ability of the first functional layer 14 to convert large-angle light into small-angle light. Configuring n<1.3 facilitates converting more large-angle light that could not be directly emitted from the display panel 01 into small-angle light to be emitted into the air, thereby further increasing the amount of light scattered into the air by the electrophoretic particles 123, thereby further increasing the display brightness of the display panel 01.

Optionally, the first functional layer 14 includes a siloxane material, and the siloxane material may contain pores.

In an embodiment of the present disclosure, as shown in FIG. 2, the thickness of the first functional layer 14 is d, 50 nm<d<1000 nm.

In the embodiments of the present disclosure, the thickness of the first functional layer 14 is configured to be within a certain range. In one aspect, the reliability of the first functional layer 14 in converting large-angle light into small-angle light may be improved, and scattered large-angle light may be prevented from still being transmitted to the side of the first functional layer 14 facing the display surface of the display panel 01. In another aspect, the thickness of the display panel 01 may be prevented from being excessively increased, which facilitates achieving a thinner display panel 01.

The applicant of the present disclosure has also found through investigation that the configuration of the first functional layer 14 may cause problems of excessive reflection of external ambient light which reduces display contrast.

In view of this, in an embodiment of the present disclosure, (m−0.2)*λ/2n≤d≤(m+0.2)*λ/2n, where d is the thickness of the first functional layer 14, m is a positive integer not greater than 5, n is the refractive index of the first functional layer, and λ is the central wavelength of the incident light on the display panel 01.

Optionally, λ=k*550 nm, and 0.8≤k≤1.2. Based on this configuration, λ is approximately the wavelength of green light. When the display panel 01 performs color display, the incident light on the display panel 01 may include red light, green light and blue light, the wavelength of green light is between the wavelength of red light and the wavelength of blue light, and the human eye is more sensitive to green light. The thickness of the first functional layer 14 is designed based on the wavelength of green light, which may reduce the reflections of green light, red light and blue light, and may comprehensively ensure that both shorter wavelength and longer wavelength light have less reflection, which facilitates significantly improving display contrast.

Exemplarily, d=m*λ/2n. Taking m=1, λ=550 nm, n=1.1 as an example, d=250 nm. As shown in FIG. 3, a schematic diagram illustrates the relationship between the reflectance and the wavelength of light when d=250 nm. When d=250 nm, the reflectance of light with a wavelength between 450 nm and 650 nm is small. That is, the reflectance of red light, green light, and blue light is small.

In the embodiments of the present disclosure, (m−0.2)*λ/2n≤d≤(m+0.2)*λ/2n is configured, and the thickness of the first functional layer 14 may be flexibly adjusted according to the wavelength of the incident light entering the display panel 01, so that the reflected light of the incident light may destructively interfere at the interface of the first functional layer 14, thereby reducing the reflection of the external ambient light, which improves the display contrast of the display panel 01 and further improving the display quality.

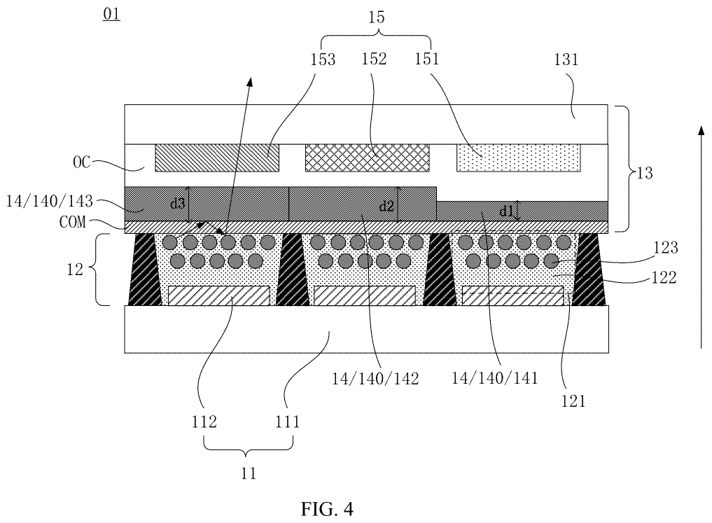

FIG. 4 is a schematic diagram of the structure of another display panel in accordance with an embodiment of the present disclosure.

In the embodiments of the present disclosure, as shown in FIG. 4, a first functional layer 14 includes a plurality of sub-portions 140, and in a direction Z perpendicular to the plane where a display panel 01 is located, different sub-portions 140 overlap with different display units 121.

Exemplarily, in the direction Z perpendicular to the plane where the display panel 01 is located, different sub-portions 140 overlap with display units 121 of different colors. Here, display units 121 of different colors may refer to different colors of light scattered by the electrophoretic particles 123 in the display units 121.

At least two of the sub-portions 140 have different thicknesses.

In the embodiments of the present disclosure, at least two sub-portions 140 are configured with different thicknesses, so the thickness of the sub-portions 140 may be flexibly configured according to the color of the light scattered by the display units 121. This facilitates configuring the thickness of the sub-portions 140 that matches the wavelength of incident light of different colors according to the wavelength of incident light of different colors, thereby facilitating the external incident light of different wavelengths to destructively interfere with the reflected light on the interfaces of the matching sub-portions 140. This facilitates further reducing the reflection of the external ambient light and improving the display contrast of the display panel 01.

In a technical solution provided by an embodiment of the present disclosure, as shown in FIG. 4, the display panel 01 further includes a color resist layer 15, and the color resist layer 15 is located on the side of the first functional layer 14 away from the electrophoretic display layer 12.

Exemplarily, the color resist layer 15 is configured in a second substrate 13, and the color resist layer 15 is located between the second base 131 and the first functional layer 14.

The color resist layer 15 includes a first color resist 151 and a second color resist 152. The plurality of sub-portions 140 include a first sub-portion 141 and a second sub-portion 142. Along the direction Z perpendicular to the plane where the display panel 01 is located, the first color resist 151 overlaps with the first sub-portion 141, and the second color resist 152 overlaps with the second sub-portion 142.

It is apparent that, in the direction Z perpendicular to the plane where the display panel 01 is located, the first color resist 151 and the second color resist 152 both overlap with the display units 121, and the color of the light scattered by a display unit 121 is the same as the color of the color resist that overlaps with the display unit 121.

The thickness d1 of the first sub-portion 141 is different from the thickness d2 of the second sub-portion 142.

It should be understood that an external first color light may pass through the first color resist 151, and a second color light may pass through the second color resist 152.

In the present technical solution, the thickness d1 of the first sub-portion 141 is configured to be different from the thickness d2 of the second sub-portion 142. The thickness d1 of the first sub-portion 141 may be configured according to the wavelength of the first color light, which facilitates making the first color incident light on the display panel 01 destructively interfere with the reflected light on the interface of the first sub-portion 141. The thickness d2 of the second sub-portion 142 may be configured according to the wavelength of the second color light, which facilitates making the second color incident light on the display panel 01 destructively interfere with the reflected light on the interface of the second sub-portion 142. The reflections of the first color light and the reflection of the second color light may be greatly reduced, which facilitates reducing the reflection of the external ambient light and improving the display contrast.

Further, by configuring the thickness d1 of the first sub-portion 141 to be different from the thickness d2 of the second sub-portion 142, more targeted angle correction may be performed on the light corresponding to the regions of different colors, which facilitates preventing display differences and color cast in different regions.

Optionally, the first color light may pass through the first color resist 151, and the second color light may pass through the second color resist 152. The wavelength of the second color light is greater than the wavelength of the first color light, and the thickness d2 of the second sub-portion 142 is greater than the thickness d1 of the first sub-portion 141.

From the formula described above, (m−0.2)*λ/2n≤d≤(m+0.2)*λ/2n, it is to be understood that, in order to ensure that the light undergoes destructive interference at the interface of the first functional layer 14, the larger for the wavelength of light, it is usually necessary to configure the thickness of the first functional layer 14 through which the light with a larger wavelength passes to be larger. This is to reduce the reflection difference between lights of different wavelengths. Based on this configuration, when the wavelength of the second color light is greater than the wavelength of the first color light, configuring the thickness d2 of the second sub-portion 142 to be greater than the thickness d1 of the first sub-portion 141 facilitates achieving a smaller reflection for both the first color light and the second color light. This facilitates improving the display contrast and also reducing the reflection difference of lights of different colors, thereby preventing display differences in different regions and the occurrence of color cast and other problems.

Continue to refer to FIG. 4, in an embodiment of the present technical solution, the color resist layer 15 further includes a third color resist 153, the plurality of sub-portions 140 further includes a third sub-portion 143, and the third color resist 153 overlaps with the third sub-portion 143 along the direction Z perpendicular to the plane where the display panel 01 is located. The external third color light may pass through the third color resist 153, and in the direction Z perpendicular to the plane where the display panel 01 is located, the display unit 121 overlapping with the third color resist 153 scatters the third color light.

The thickness of at least one of the first sub-portion 141 and the second sub-portion 142 is different from the thickness of the third sub-portion 143.

That is, the thickness of the third sub-portion 143 may be different from the thickness of the first sub-portion 141 and different from the thickness of the second sub-portion 142, or the thickness of the third sub-portion 143 may be the same as the thickness of one of the first sub-portion 141 and the second sub-portion 142, but different from the other.

In the illustrated embodiment, the display panel 01 includes the first color resist 151, the second color resist 152, and the third color resist 153, which may allow three different colors of external light to enter the display panel 01, and then the display units 121 may be used to scatter the three different colors of light, which facilitates implementing color display of the display panel 01.

Optionally, the first color resist 151 is a blue color resist, the second color resist 152 is a green color resist, and the third color resist 153 is a red color resist.

Further, configuring the thickness of the third sub-portion 143 to be different from the thickness of at least one of the first sub-portion 141 and the second sub-portion 142 facilitates the flexible configuring the thickness of the third sub-portion 143 according to the wavelength of the third color light. This reduces the reflection of the third color light, thereby further improving the display contrast.

Optionally, as shown in FIG. 4, the thickness d1 of the first sub-portion 141 is different from the thickness d3 of the third sub-portion 143, and the thickness d2 of the second sub-portion 142 is the same as the thickness d3 of the third sub-portion 143. In this scenario, the wavelength of the third color light and the wavelength of the second color light may be closer to each other than the wavelength of the third color light and the wavelength of the first color light. While ensuring that the reflection of the third color light may be effectively reduced, the structural complexity of the first functional layer 14 may also be reduced, which facilitates reducing the manufacturing difficulty of the display panel 01, and saves costs.

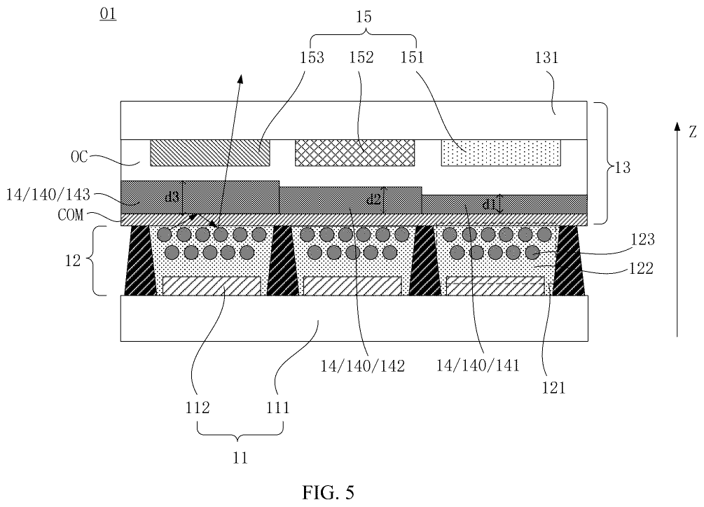

Optionally, as shown in FIG. 5, in a schematic diagram of another display panel in accordance with an embodiment of the present disclosure, a thickness d3 of a third sub-portion 143 is different from a thickness d1 of a first sub-portion 141 and is different from a thickness d2 of a second sub-portion 142.

Based on this configuration, the thickness d3 of the third sub-portion 143 may be configured to match the wavelength of a third color light, which facilitates achieving destructive interference of the reflected light of the third color light at the interface of the third sub-portion 143. This facilitates greatly reducing the reflection of the third color light, which facilitates further reducing the reflection of the external ambient light, thereby improving the display contrast.

Exemplarily, as shown in FIG. 5, the third color light may pass through a third color resist 153, the wavelength of the third color light is greater than the wavelength of a second color light, and the thickness d3 of the third sub-portion 143 is greater than the thickness d2 of the second sub-portion 142.

From the formula described above, (m−0.2)*λ/2n≤d≤(m+0.2)*λ/2n, it is to be understood that, in order to ensure that the light undergoes destructive interference at the interface of the first functional layer 14, the larger for the wavelength of light, it is usually necessary to configure the thickness of the first functional layer 14 through which the light with a larger wavelength passes to be larger. This is to reduce the reflection difference between lights of different wavelengths. Based on this configuration, when the wavelength of the third color light is greater than the wavelength of the second color light, configuring the thickness d3 of the third sub-portion 143 to be greater than the thickness d2 of the second sub-portion 142 facilitates achieving a smaller reflection of both the second color light and the third color light. This facilitates improving the display contrast and also reducing the reflection difference of lights of different colors, thereby preventing display differences in different regions and color cast problems.

In an embodiment of the present disclosure, as shown in FIG. 2, the display panel 01 further includes a color resist layer 15, and the color resist layer 15 is located on the side of the first functional layer 14 away from the electrophoretic display layer 12.

Exemplarily, as shown in FIG. 2, the color resist layer 15 is configured in the second substrate 13, and the color resist layer 15 is located between the second base 131 and the first functional layer 14.

Exemplarily, the color resist layer 15 includes a first color resist 151, a second color resist 152, and a third color resist 153.

The color resist layer 15 and the first functional layer 14 include a planarization layer OC. The planarization layer OC may cover the color resist layer 15.

In the embodiments of the present disclosure, the color resist layer 15 is configured on the side of the first functional layer 14 away from the electrophoretic display layer 12, which facilitates preventing the problem of absorption loss caused by the light scattered by the electrophoretic particles 123 being reflected by the first functional layer 14 and propagating a plurality of times in the color resist layer 15. This facilitates further ensuring the amount of light scattered into the air and improving the display brightness.

Further, the planarization layer OC is configured between the color resist layer 15 and the first functional layer 14. In one aspect, it facilitates ensuring the flatness of the display panel 01. In another aspect, in the process of preparing the display panel 01, the color resist layer 15 may be first prepared on the second substrate 13, then the planarization layer OC is prepared, and then the first functional layer 14 is prepared. This facilitates preventing the problem that the processing solution will enter the first functional layer 14 during the preparation of the planarization layer OC, thereby causing the refractive index of the first functional layer 14 to change.

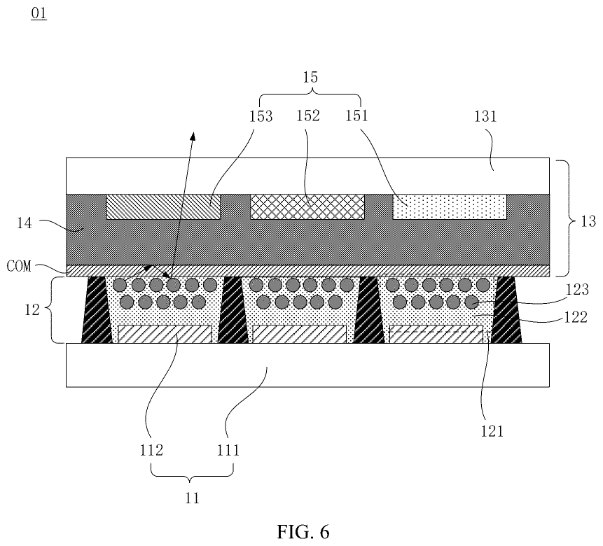

FIG. 6 is a schematic diagram of the structure of another display panel in accordance with an embodiment of the present disclosure.

In one embodiment of the present disclosure, as shown in FIG. 6, a display panel 01 further includes a color resist layer 15, and the color resist layer 15 is located on the side of a first functional layer 14 away from an electrophoretic display layer 12.

Exemplarily, as shown in FIG. 6, the color resist layer 15 is configured in a second substrate 13, and the color resist layer 15 is located between a second base 131 and the first functional layer 14.

Exemplarily, the color resist layer 15 includes a first color resist 151, a second color resist 152, and a third color resist 153.

The first functional layer 14 is affixed to the color resist layer 15. That is, after the color resist layer 15 is prepared, the first functional layer 14 is directly prepared on the color resist layer 15, and the first functional layer 14 may fill the gaps between adjacent color resists in the color resist layer 15.

In the embodiments of the present disclosure, the first functional layer 14 may be reused as a planarization layer to ensure the flatness of the display panel 01 while converting the large-angle light scattered by electrophoretic particles 123 into small-angle light for emission. In this way, there is no need to prepare an additional planarization layer, which facilitates saving materials and reducing the preparation cost of the display panel 01.

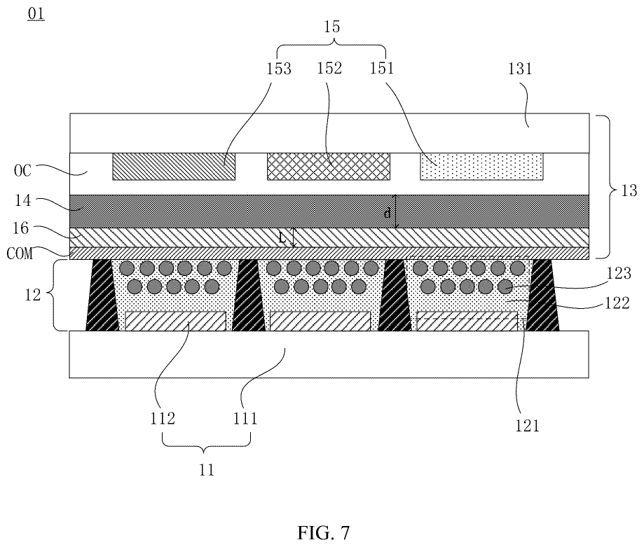

FIG. 7 is a schematic diagram of the structure of another display panel in accordance with an embodiment of the present disclosure.

In an embodiment of the present disclosure, as shown in FIG. 7, the display panel 01 further includes a protective layer 16, which is located between a first functional layer 14 and an electrophoretic display layer 12, and the protective layer 16 may be used to prevent liquid from entering the first functional layer 14.

Exemplarily, the protective layer 16 includes at least one of silicon nitride and silicon oxide.

The applicant of the present disclosure has found through investigation that the material in the first functional layer 14 is prone to failure after being penetrated by liquid, resulting in a change in the refractive index of the first functional layer 14, while the electrophoretic display layer 12 contains an electrophoretic liquid 122.

In view of this, in the embodiments of the present disclosure, a protective layer 16 is configured between the first functional layer 14 and the electrophoretic display layer 12, and the protective layer 16 is used to block the liquid in the electrophoretic display layer 12 from entering the first functional layer 14. This facilitates the first functional layer 14 having a relatively stable refractive index and further facilitates the reliability of the first functional layer 14 in converting large-angle scattered light into small-angle light for emission.

Optionally, the thickness of the protective layer 16 is L, where 50 nm<L<300 nm, so as to ensure that the protective layer 16 prevents liquid from entering the first functional layer 14.

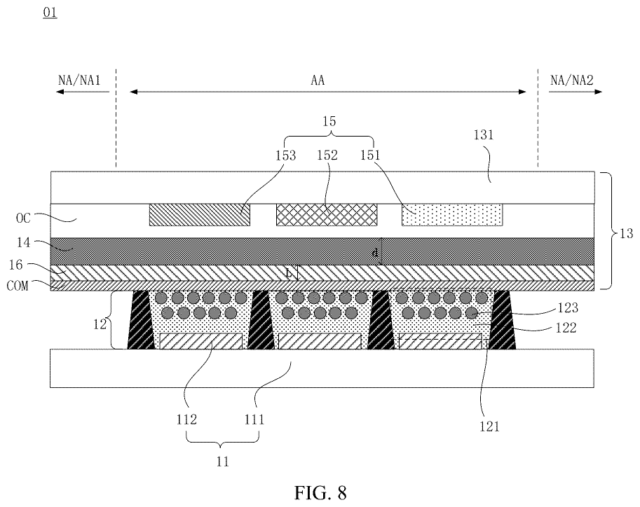

Optionally, as shown in FIG. 8, in a schematic diagram of another display panel in accordance with an embodiment of the present disclosure, a display panel 01 includes a display area AA and a non-display area NA. The non-display area NA surrounds at least a part of the display area AA, and a first functional layer 14 and a protective layer 16 both extend from the display area AA to the non-display area NA.

Exemplarily, as shown in FIG. 8, the non-display area NA includes a first non-display area NA1 and a second non-display area NA2 located on opposite sides of the display area AA. One end of the first functional layer 14 extends to the first non-display area NA1, and the other end extends to the second non-display area NA2. One end of the protective layer 16 extends to the first non-display area NA1, and the other end extends to the second non-display area NA2.

Since display units 121 are located in the display area AA, an electrophoretic liquid 122 in a display unit 121 is usually also located in the display area AA. Therefore, the first functional layer 14 and the protective layer 16 are configured to extend from the display area AA to the non-display area NA. This may prevent the electrophoretic liquid 122 from overflowing into the first functional layer 14 at the edge of the display area AA, which facilitates improving the reliability of the protective layer 16 in blocking the electrophoretic liquid 122 from entering the first functional layer 14.

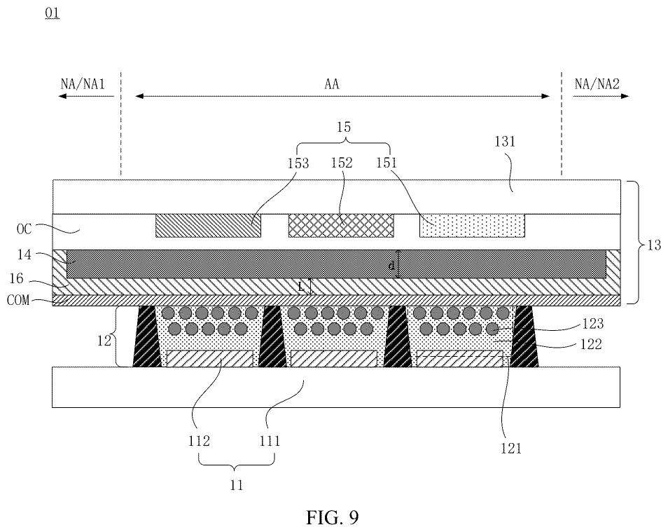

Further, as shown in FIG. 9, in a schematic diagram of the structure of another display panel in accordance with an embodiment of the present disclosure, a protective layer 16 extends to the side of a first functional layer 14 located in a non-display area NA.

Based on this configuration, the liquid in the packaging process may be prevented from entering the first functional layer 14 through the side of the first functional layer 14 located in the non-display area NA, which facilitates further improving the protective effect of the protective layer 16 on the first functional layer 14.

In an embodiment of the present disclosure, as shown in FIG. 7, the display panel 01 further includes a common electrode COM, the common electrode COM is located between the first functional layer 14 and the electrophoretic display layer 12, and the protective layer 16 is located between the common electrode COM and the first functional layer 14.

From the above analysis, it should be understood that the electrophoretic particles 123 in the electrophoretic display layer 12 may move under the action of the electric field between a driving electrode 112 and the common electrode COM. In the disclosed embodiment, the common electrode COM is configured on the side of the first functional layer 14 facing the electrophoretic display layer 12, and the protective layer 16 is configured between the common electrode COM and the first functional layer 14, which facilitates reducing the distance between the common electrode COM and the electrophoretic particles 123, thereby facilitating improving the driving ability of the electric field between the driving electrode 112 and the common electrode COM on the electrophoretic particles 123.

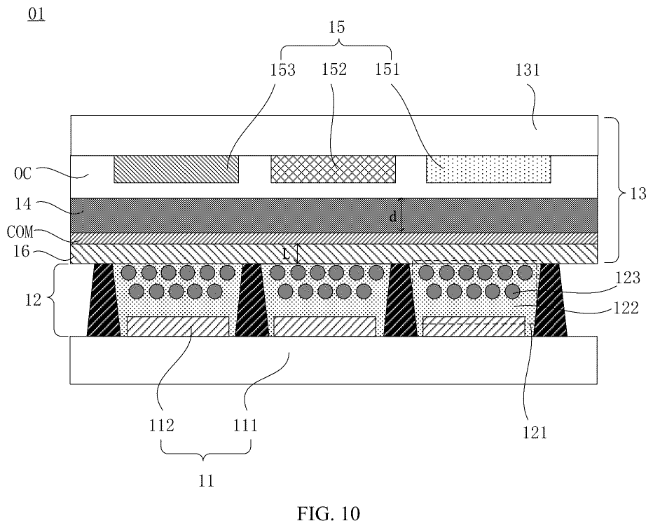

In another embodiment of the present disclosure, as shown in FIG. 10, in a schematic diagram of another display panel in accordance with an embodiment of the present disclosure, the display panel 01 also includes a common electrode COM, and the common electrode COM is located between a first functional layer 14 and an electrophoretic display layer 12. A protective layer 16 is located between the common electrode COM and the electrophoretic display layer 12.

In the illustrated embodiment, the common electrode COM is configured on the side of the first functional layer 14 facing the electrophoretic display layer 12, and the protective layer 16 is configured between the common electrode COM and the electrophoretic display layer 12. While ensuring that the distance between the common electrode COM and the electrophoretic display layer 12 is not too large, the protective layer 16 may also be used to prevent the liquid in the electrophoretic display layer 12 from corroding the common electrode COM, which facilitates improving the service life of the display panel 01.

In an embodiment of the present disclosure, continue to refer to FIG. 2, in a direction Z perpendicular to the plane where the display panel 01 is located, the distance between the first functional layer 14 and the electrophoretic display layer 12 is h1, h1<0.2*x, where x is the opening size of the display units 121.

Exemplarily, as shown in FIG. 2, the display units 121 may be a cofferdam-type structure, and a spacing structure 124 is included between two adjacent display units 121, where x is the distance between the two spacing structures 124 located on opposite sides of the same display unit 121.

In the embodiments of the present disclosure, the distance between the first functional layer 14 and the electrophoretic display layer 12 is configured within a certain range. This facilitates making the light scattered by the electrophoretic particles 123 in the display units 121 return to the display units 121 after being reflected by the first functional layer 14 and ultimately scattered into the air through the electrophoretic particles 123 in the display units 121. This may prevent a scenario where the scattered light enters the display units 121 corresponding to other color resists after being reflected by the first functional layer 14 and ultimately cannot be emitted into the air, which facilitates further improving the display brightness of the display panel 01.

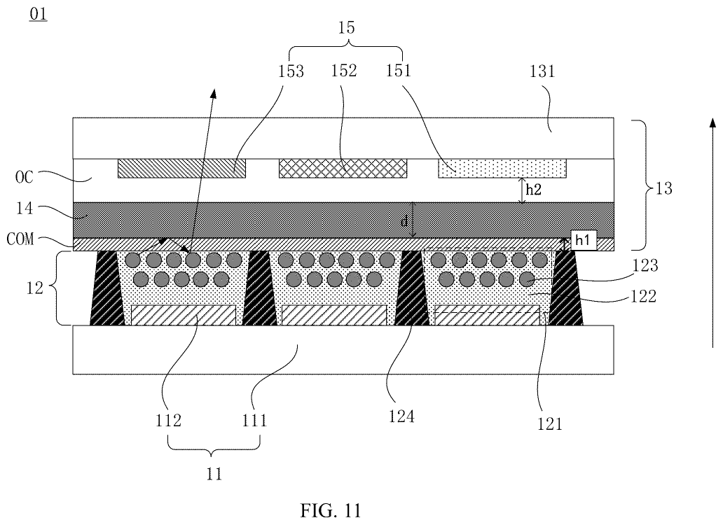

FIG. 11 is a schematic diagram of the structure of another display panel in accordance with an embodiment of the present disclosure.

In an embodiment of the present disclosure, as shown in FIG. 11, in a direction Z perpendicular to the plane where a display panel 01 is located, the distance between a first functional layer 14 and an electrophoretic display layer 12 is h1.

The display panel 01 further includes a color resist layer 15, which is located on the side of the first functional layer 14 away from the electrophoretic display layer 12. The color resist layer 15 may include a first color resist 151, a second color resist 152, and a third color resist 153 of different colors. In the direction Z perpendicular to the plane where the display panel 01 is located, the distance between the first functional layer 14 and the color resist layer 15 is h2.

Where, h1<h2.

In the embodiments of the present disclosure, a small distance is configured between the first functional layer 14 and the electrophoretic display layer 12. This facilitates making the light scattered by electrophoretic particles 123 in display units 121 return to the display units 121 after being reflected by the first functional layer 14, and ultimately scattered into the air through the electrophoretic particles 123 in the display units 121. This may prevent the scenario where the scattered light enters the display units 121 corresponding to other color resists after being reflected by the first functional layer 14 and ultimately cannot be emitted into the air, which facilitates further improving the display brightness of the display panel 01.

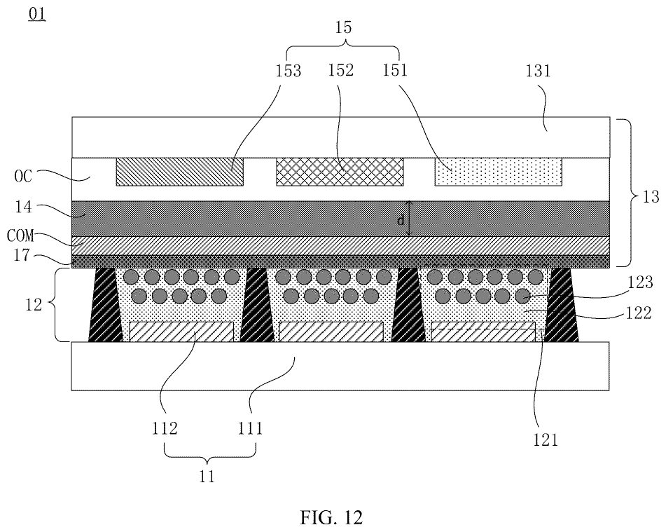

FIG. 12 is a schematic diagram of the structure of another display panel in accordance with an embodiment of the present disclosure.

In an embodiment of the present disclosure, as shown in FIG. 12, display units 121 may be a cofferdam-type structure, a sealing layer 17 is configured on an electrophoretic display layer 12, the sealing layer 17 is located on the side of the electrophoretic display layer 12 facing the display surface of a display panel 01, and the refractive index of a first functional layer 14 is less than the refractive index of the sealing layer 17.

It should be noted that the sealing layer 17 may be affixed to spacing structures 124 or may be separated from the spacing structures 124. FIG. 12 merely illustrates the scenario where the sealing layer 17 is affixed to the spacing structures 124.

In the embodiments of the present disclosure, the refractive index of the first functional layer 14 is configured to be relatively small. This is beneficial for the light with a large angle, scattered by the electrophoretic particles 123 after passing through the sealing layer 17, to be converted into light with a smaller angle through the first functional layer 14. This facilitates increasing the amount of light scattered into the air by the electrophoretic particles 123, thereby increasing the display brightness of the display panel 01 and improving the display quality.

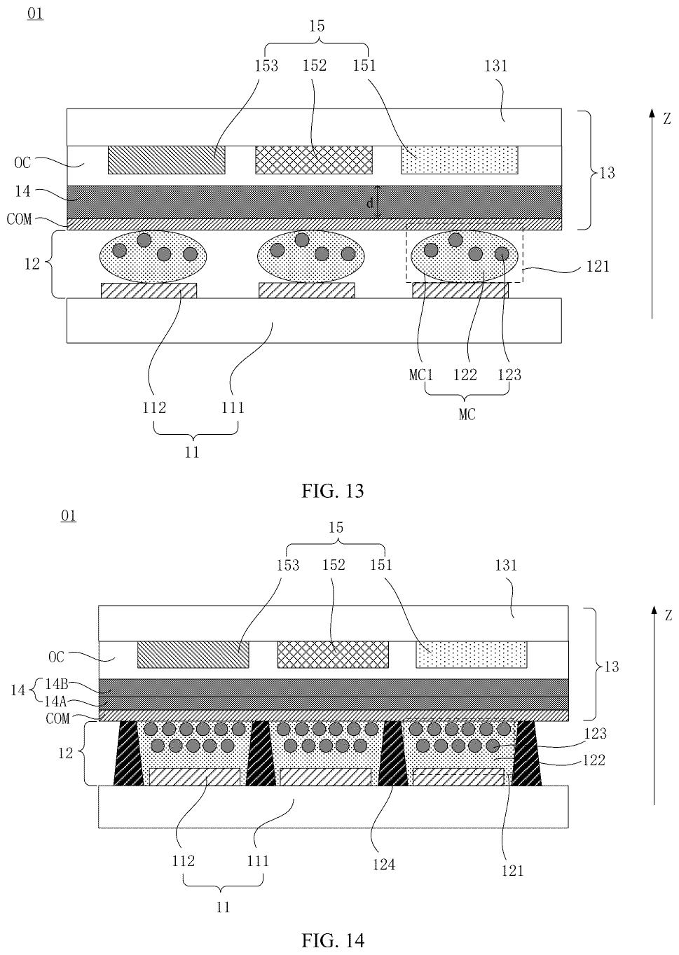

FIG. 13 is a schematic diagram of the structure of another display panel in accordance with an embodiment of the present disclosure.

In an embodiment of the present disclosure, as shown in FIG. 13, display units 121 include a microcapsule structure MC, where the microcapsule structure MC includes an electrophoretic liquid 122, electrophoretic particles 123 and a microcapsule wall MC1, and the microcapsule wall MC1 is used to encapsulate the electrophoretic liquid 122 and the electrophoretic particles 123.

The refractive index of the first functional layer 14 is smaller than the refractive index of the microcapsule wall MC1.

It should be noted that the display units 121 may include at least one microcapsule structure MC, and FIG. 13 merely illustrates the scenario where the display units 121 include one microcapsule structure MC.

In the embodiments of the present disclosure, the refractive index of the first functional layer 14 is configured to be relatively small, which facilitates converting the light with a relatively large angle, scattered by the electrophoretic particles 123 after passing through the microcapsule wall MC1, into light with a small angle through the first functional layer 14. This facilitates increasing the amount of light scattered into the air by the electrophoretic particles 123, thereby increasing the display brightness of the display panel 01 and improving the display quality.

FIG. 14 is a schematic diagram of the structure of another display panel in accordance with an embodiment of the present disclosure.

In an embodiment of the present disclosure, as shown in FIG. 14, a first functional layer 14 includes a first sub-layer 14A and a second sub-layer 14B, and the first sub-layer 14A is located on the side of the second sub-layer 14B close to an electrophoretic display layer 12. That is, the first sub-layer 14A and the second sub-layer 14B may be stacked, and the second sub-layer 14B is closer to the display surface of a display panel 01 than the first sub-layer 14A.

The refractive index of the first sub-layer 14A is not greater than the refractive index of the second sub-layer 14B.

Exemplarily, the refractive index of the first sub-layer 14A may be equal to the refractive index of the second sub-layer 14B. In this scenario, the first sub-layer 14A and the second sub-layer 14B may be prepared using the same material. Based on this configuration, when the thickness of the first functional layer 14 is large, the first functional layer 14 may be prepared in layers, which facilitates reducing the difficulty of preparing the first functional layer 14.

Exemplarily, the refractive index of the first sub-layer 14A may be less than the refractive index of the second sub-layer 14B. Based on this configuration, it facilitates destructive interference of the reflected light of the external ambient light at the interface of the first sub-layer 14A and the interface of the second sub-layer 14B. This facilitates reducing the reflection of the external ambient light, thereby facilitating improving the display contrast and the display quality of the display panel 01.

It should be noted that when the first functional layer 14 is configured in layers, the first sub-layer 14A and the second sub-layer 14B may be affixed, or some other film layers may be configured between them.

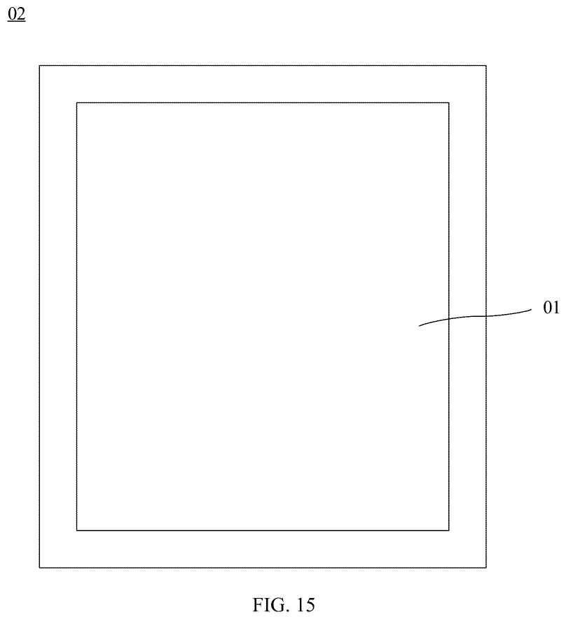

FIG. 15 is a schematic diagram of a display device in accordance with an embodiment of the present disclosure.

As shown in FIG. 15, an embodiment of the present disclosure provides a display device 02, which includes a display panel 01 in accordance with any one of the embodiments described above. Exemplarily, the display device 02 may be an electronic device such as an electronic reader, an electronic price tag, an electronic billboard, etc., which is not specifically limited by the present disclosure.

In the display device 02, a first functional layer 14 is configured on the side of electrophoretic particles 123 facing the display surface of the display panel 01, so that the light scattered by the electrophoretic particles 123 for display may pass through the first functional layer 14. Since the refractive index of the first functional layer 14 is relatively small, the large-angle light scattered by the electrophoretic particles 123 may be reflected back to an electrophoretic display layer 12 at the interface of the first functional layer 14. After being scattered again by the electrophoretic particles 123 in the electrophoretic display layer 12, the light scattered may be easily converted into small-angle light and emitted into the air as light with a light angle less than the total reflection angle. That is, the large-angle light that initially cannot be directly emitted from the display panel 01 into the air may be converted into small-angle light and emitted into the air, which facilitates increasing the amount of light scattered into the air by the electrophoretic particles 123, thereby facilitating increasing of the display brightness of the display panel 01 and improving the display quality.

In the above embodiments of the present disclosure, the first functional layer is configured on the side of the electrophoretic particles facing the display surface of the display panel, so that the light scattered by the electrophoretic particles for display may pass through the first functional layer. Since the refractive index of the first functional layer is relatively small, the large-angle light scattered by the electrophoretic particles may be reflected back to the electrophoretic display layer at the interface of the first functional layer. After being scattered again by the electrophoretic particles in the electrophoretic display layer, it is easy to be converted into small-angle light and emitted into the air as light with a light angle less than the total reflection angle. That is, the large-angle light that could not be directly emitted from the display panel into the air may be converted into small-angle light emitted into the air, which facilitates increasing the amount of light scattered into the air by the electrophoretic particles, thereby facilitating increasing the display brightness of the display panel and improving the display quality.

The above description includes merely some embodiments of the present disclosure and is not intended to limit the present disclosure. Any modifications, equivalent substitutions, improvements, etc., made within the spirit and principles of the present disclosure shall still fall within the scope of protection of the present disclosure.

What is claimed is:

1. A display panel, comprising:
a first substrate and an electrophoretic display layer located on one side of the first substrate, the electrophoretic display layer includes a plurality of display units, and a display unit includes an electrophoretic liquid and a plurality of electrophoretic particles located in the electrophoretic liquid; and
the display panel further includes a first functional layer, and the first functional layer is located on a side of the electrophoretic display layer facing a display surface of the display panel,
wherein the first functional layer is a low refractive index layer.

2. The display panel according to claim 1, wherein a refractive index of the first functional layer is n, and n<1.5.

3. The display panel according to claim 2, wherein n<1.3.

4. The display panel according to claim 1, wherein a thickness of the first functional layer is d, and 50 nm<d<1000 nm.

5. The display panel according to claim 1, wherein (m−0.2)*λ/2n≤d≤(m+0.2)*λ/2n, d is a thickness of the first functional layer, m is a positive integer not greater than 5, n is a refractive index of the first functional layer, and λ is a central wavelength of incident light on the display panel.

6. The display panel according to claim 5, wherein λ=k*550 nm, and 0.8≤k≤1.2.

7. The display panel according to claim 1, wherein the first functional layer includes a siloxane material.

8. The display panel according to claim 1, wherein:
the first functional layer includes a plurality of sub-portions, and in a direction perpendicular to a plane where the display panel is located, different sub-portions overlap with different display units; and
at least two of the sub-portions have different thicknesses.

9. The display panel according to claim 8, wherein:
the display panel further includes a color resist layer, and the color resist layer is located on a side of the first functional layer away from the electrophoretic display layer;
the color resist layer includes a first color resist and a second color resist, the plurality of sub-portions include a first sub-portion and a second sub-portion, and along the direction perpendicular to the plane where the display panel is located, the first color resist overlaps with the first sub-portion, and the second color resist overlaps with the second sub-portion; and
the first sub-portion and the second sub-portion have different thicknesses.

10. The display panel according to claim 9, wherein:
a first color light passes through the first color resist, and a second color light passes through the second color resist; and
a wavelength of the second color light is greater than a wavelength of the first color light, and a thickness of the second sub-portion is greater than a thickness of the first sub-portion.

11. The display panel according to claim 10, wherein:
the color resist layer further includes a third color resist, the plurality of sub-portions further includes a third sub-portion, and along the direction perpendicular to the plane where the display panel is located, the third color resist overlaps with the third sub-portion; and
a thickness of at least one of the first sub-portion and the second sub-portion is different from a thickness of the third sub-portion.

12. The display panel according to claim 11, wherein the thickness of the third sub-portion is different from the thickness of the first sub-portion and different from the thickness of the second sub-portion.

13. The display panel according to claim 11, wherein:
a third color light passes through the third color resist, a wavelength of the third color light is greater than the wavelength of the second color light, and the thickness of the third sub-portion is greater than the thickness of the second sub-portion.

14. The display panel according to claim 11, wherein the first color resist is a blue color resist, the second color resist is a green color resist, and the third color resist is a red color resist.

15. The display panel according to claim 1, wherein:
the display panel further includes a color resist layer, and the color resist layer is located on a side of the first functional layer away from the electrophoretic display layer; and
a planarization layer is between the color resist layer and the first functional layer.

16. The display panel according to claim 1, wherein:
the display panel further includes a color resist layer, and the color resist layer is located on a side of the first functional layer away from the electrophoretic display layer; and
the first functional layer is adjacent to the color resist layer.

17. The display panel according to claim 1, wherein the display panel further includes a protective layer, the protective layer is located between the first functional layer and the electrophoretic display layer, and the protective layer includes at least one of silicon nitride and silicon oxide.

18. The display panel according to claim 17, wherein the display panel includes a display area and a non-display area, the non-display area surrounds at least a part of the display area, and the first functional layer and the protective layer both extend from the display area to the non-display area.

19. The display panel according to claim 18, wherein the protective layer extends to a side of the first functional layer located in the non-display area.

20. The display panel according to claim 17, wherein a thickness of the protective layer is L, and 50 nm<L<300 nm.

21. The display panel according to claim 17, wherein the display panel further includes a common electrode, the common electrode is located between the first functional layer and the electrophoretic display layer, and the protective layer is located between the common electrode and the first functional layer.

22. The display panel according to claim 17, wherein the display panel further includes a common electrode, the common electrode is located between the first functional layer and the electrophoretic display layer, and the protective layer is located between the common electrode and the electrophoretic display layer.

23. The display panel according to claim 1, wherein, in a direction perpendicular to a plane of the display panel, a distance between the first functional layer and the electrophoretic display layer is h1, and h1<0.2*x, wherein x is an opening size of the display unit.

24. The display panel according to claim 23, wherein a spacing structure is included between two adjacent display units, and x is a distance between two spacing structures located on opposite sides of a same display unit.

25. The display panel according to claim 1, wherein:
in a direction perpendicular to a plane where the display panel is located, a distance between the first functional layer and the electrophoretic display layer is h1; and
the display panel further includes a color resist layer, and the color resist layer is located on a side of the first functional layer away from the electrophoretic display layer, in the direction perpendicular to the plane where the display panel is located, a distance between the first functional layer and the color resist layer is h2,
wherein, h1<h2.

26. The display panel according to claim 1, wherein:
the display unit includes a microcapsule structure, and the microcapsule structure includes the electrophoretic liquid, the electrophoretic particles, and a microcapsule wall encapsulating the electrophoretic liquid and the electrophoretic particles; and
a refractive index of the first functional layer is lower than a refractive index of the microcapsule wall.

27. The display panel according to claim 1, wherein a sealing layer is configured on the electrophoretic display layer, the sealing layer is located on the side of the electrophoretic display layer facing the display surface of the display panel, and a refractive index of the first functional layer is smaller than a refractive index of the sealing layer.

28. The display panel according to claim 1, wherein:
the first functional layer includes a first sub-layer and a second sub-layer, and the first sub-layer is located on a side of the second sub-layer closer to the electrophoretic display layer; and
a refractive index of the first sub-layer is not greater than a refractive index of the second sub-layer.

29. A display device, comprising a display panel, wherein the display panel includes:
a first substrate and an electrophoretic display layer located on one side of the first substrate, the electrophoretic display layer includes a plurality of display units, and a display unit includes an electrophoretic liquid and a plurality of electrophoretic particles located in the electrophoretic liquid; and
the display panel further includes a first functional layer, and the first functional layer is located on a side of the electrophoretic display layer facing a display surface of the display panel,
wherein the first functional layer is a low refractive index layer.
